(19) United States
(12) Patent Application Publication
(10) Pub. No.: US 2025/0073599 A1
(43) Pub. Date: Mar. 6, 2025

(54) DETECTING 3D MODEL CLONES IN MOBILE GAMES

(71) Applicant: Ohio State Innovation Foundation, Columbus, OH (US)

(72) Inventors: Chaoshun ZUO, Columbus, OH (US); Zhiqiang LIN, Columbus, OH (US)

(21) Appl. No.: 18/725,850

(22) PCT Filed: Jan. 4, 2023
(86) PCT No.: PCT/US2023/060107

§ 371 Date: Jul. 1, 2024

Related U.S. Application Data
(60) Provisional application No. 63/296,240, filed on Jan. 4, 2022.

(51) Int. Cl. A63F 13/75; A63F 13/52; A63F 13/60

(52) U.S. Cl. CPC A63F 13/75; A63F 13/52; A63F 13/60; A63F 2300/6607

(57) ABSTRACT

Methods for detecting 3D model clones in computer games. in accordance with the methods. 3D models are extracted from game files. A value-insensitive normalization algorithm is applied to the extracted 3D models, which are then indexed by using a computed hash value. By comparing the 3D model indexes. cloned static 3D models are identified. If they are animated-meshes models. skeleton and motion track information is used to further narrow down like 3D models and a pair-wise comparison is used to detect the animated cloned models.

### CROSS-REFERENCE TO RELATED APPLICATION

This application claims priority to U.S. Provisional Patent Application No. 63/296,240, filed Jan. 4, 2022, entitled “3DSCOPE: DETECTING 3D MODEL CLONES IN METAVERSE,” the disclosure of which is expressly incorporated herein by reference in its entirety.

### STATEMENT OF GOVERNMENT SUPPORT

This invention was made with government support under grant/contract number 1834215 awarded by the National Science Foundation. The government has certain rights in the invention.

### BACKGROUND

A component in a modern computer games is its scene, which is a displayed state with distinctive information of the game. To have immerse experiences for players, many modern games (e.g., World of Warcraft and FIFA) all have been using 3D instead of plain old 2D. Specifically, the static 3D objects (including its color and texture) along with the (optional) animations of the 3D objects together forming 3D models, are the fundamental building blocks for the scene, and they directly impact the player's experience of the game. However, 3D models are tedious and time-consuming to make, and they are often created by professional artists, an expensive human resource. Therefore, 3D models have become one of the core assets for game producers. More broadly, since 3D models are the key ingredients in the metaverse, it is undoubtedly that they will become even more important than ever along with the metaverse development.

Unfortunately, 3D models can be easily cloned, reused, or resold by attackers. There are many reasons for that. Particularly, 3D models often need to be rendered at the client side instead of servers for better user experience (e.g., low network latency), and therefore client devices often inevitably hold a copy of the 3D models. Moreover, currently there is a lack of strong protection (e.g., physical dongles, software access keys, or obfuscations) for the 3D models at the client side. An attacker can easily extract the 3D models from a game binary (e.g., using AssetStudio to extract assets for games built with Unity engine, or UE Viewer for Unreal Engine).

There have been numerous reports or complains about 3D model stealing, which is even true for popular games. For example, the online game Magnet Simulator (which has been visited for more than 145 million times) had been taken down because it contained stolen 3D models from game Bubble Gum Simulator. Obviously, the victims of 3D model stealing are the original creators, but game developers could also become the victim if they are not aware of the origin of 3D models.

Therefore, it is desirable to identify the cloned 3D models at scale. However, there is no solution to solve this problem other than human beings spotting whether an object is a cloned copy. It is also a challenging task to create the index for a 3D model. At a high level, a hash (e.g., MD5, SHA256) of the 3D model file may be used for the indexing, as in the copyrighted movie detection. However, this approach is not robust because the 3D model can be easily modified. More specifically, a static 3D object is composed of the three-dimensional vertices, the faces defined by the vertices, and the materials such as textures. As such, a 3D model can be squashed or stretched which can significantly change the vertices that represent the 3D model but preserve the same visual effect. In addition, due to the optimization of the development tools, it is quite common for the 3D model extracted from the game to be different from the original one in terms of the raw data such as the vertices and faces.

### SUMMARY

As such, the present disclosure presents systems and methods to systematically detect 3D models clones in computer games. In particular, a 3D model indexing approach, at scale is described to detect the clones. Two insights are gathered by the approach of the present disclosure. While squashing or stretching could have changed the vertices, the relationship among vertices and faces are still preserved in the cloned 3D models. Therefore, a first insight is to abstract their relationship, from which to derive an index for the static 3D models. For the 3D models with animation, since there is one more dimension, namely the time dimension which defines the motion (i.e., the movement track) of the 3D objects, the second insight is to measure the Euclidean distance of the tracks between the two compared models using interpolation to detect the clones.

In accordance with and aspect of the present disclosure, a method for detecting 3D clone in a game is disclosed. The method may include extracting 3D models from a game file; using a value-insensitive normalization algorithm on extracted 3D models and indexing the extracted 3D models using a computed hash value to create 3D model indexes; and comparing the 3D model indexes to identify cloned static 3D models.

In accordance with another aspect of the disclosure, a method of determining 3D clones in a graphics-based application is disclosed. The method may include using shape information of a graphical object to generate a hash value of the graphical object; indexing the graphical objects based on the hash values; and determining static 3D clones from the indexed graphical objects.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example of a cloned 3D trojan horse model;

FIG. 2 illustrates operations of an indexing algorithm with examples;

FIG. 3A illustrates the rotation information of the leftUpLeg bone in a walk animation for a human-like model Mₒ;

FIG. 3B illustrates data of the bone in FIG. 3A in the Mₑ;

FIG. 3C illustrates rotation angles of the bone of FIG. 3A in the x-axis;

FIG. 3D illustrates an example interpolation curves of the data in FIG. 3C;

FIG. 4 illustrates an example model average faces distribution across games;

FIG. 5A illustrates an example models distribution;

FIG. 5B illustrates an example skeleton distribution;

FIG. 5C illustrates an example overlapping rate among suspicious games;

FIG. 6A illustrates an example static 3D models distribution;

FIG. 6B illustrates an example animated 3D models distribution;

FIG. 6C illustrates an example game models sharing rate distribution; and

FIG. 7 is an example computing device.

### DETAILED DESCRIPTION

### Overview

A 3D model can be easily stolen, cloned, and reused from a mobile game. There are hundreds of thousands of mobile games today and understanding the landscape of the 3D model reuse (or clones) among mobile games is an element of the present disclosure. In particular, there are no tools or algorithms that are designed to detect 3D model clones at scale. As such, the present disclosure describes an algorithm that is efficient and scalable.

For instance, given n 3D models, a pair-wise comparison would require C2 combinations, which is impractical. For each single 3D model, it has many vertices, edges, faces, keyframes, and motions. The algorithm disclosed herein is efficient when dealing with the complicated objects. Regarding scalability, there are hundreds of thousands of mobile games, where each game contains tens or hundreds of 3D models. Thus, the algorithm is scalable and handles a large set of games. The detected cloned models should be really the cloned models, since it concerns the reputation of the games. That is, it is desirable not to have false positives, while allowing some false negatives during our measurement. Further, when extracting a 3D model from a game, noise can be easily introduced. Meanwhile, when integrating the model into the game, the IDE tool can also change the raw data of the mesh as well as its animation data. Therefore, the algorithm should be robust to these noises.

While intuitively a 3D model clone can be detected by simply comparing the hash of the 3D files, it turns out this approach will not work, since even for the same static 3D model (without any additional intended changes at all from the game developer), extracting it from one game and then integrating into another will change the raw data of the meshes. When handling the animated 3D models, the change could be more dramatic since some keyframes could be dropped. A robust approach is thus needed to deal with these two major changes.

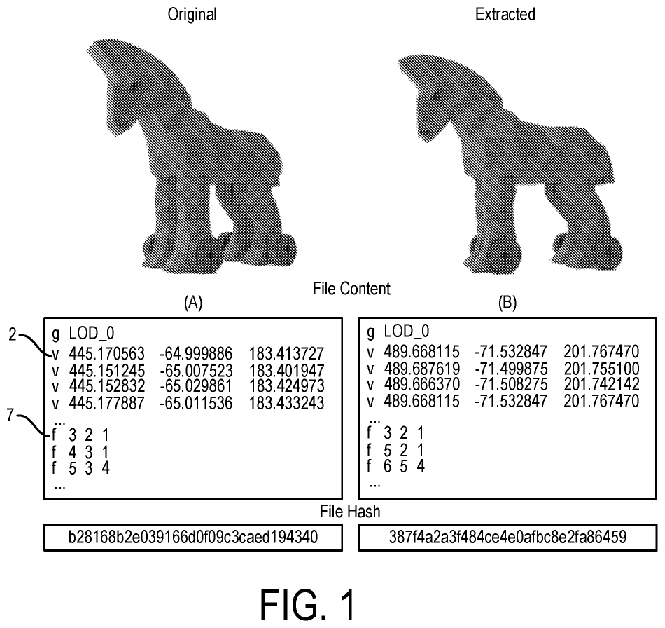

The solution of the present disclosure also handles noise in static 3D models. The raw data of a mesh could be changed during 3D model extraction. In particular, there may changes of a mesh during extraction. For the illustration purpose, assume Mₒ denotes the original 3D model and Mₑ denotes the extracted model from an APK, the types of changes observed may be:
(1) The coordinates of vertices. The x, y, z coordinates of the same vertices may be changed. This is fundamentally because (1) an attacker may squash or stretch the model which would change the vertices coordinates while reusing a cloned model, and (2) the 3D model extracting tools (such as AssetStudio) may adjust the model too (e.g., it has a model extraction precision parameter, its default value is 25%). FIG. 1 shows a concrete example of Mₒ and Mₑ in which Mₑ has been stretched to 110% from Mₒ, and it can be seen that the x, y, z coordinates for all the vertices have been changed between the two models, but the shape still looks identical.
(2) The number of vertices. Besides the changes of the coordinates of the vertices, some duplicated vertices may be also dropped during the model extraction or integration.
(3) The order of the vertices. The order of the vertices may be changed, though this also does not have visual effects on the shape.
(4) The order of the faces. Since there is no order requirement among faces, the order of some faces may be changed.

Consequently, the hash values of the 3D models may not be used for the indexing, as shown in FIG. 1, and further described below. It can also be seen that although the coordinates of the vertices could have been changed, their relationship and the number of faces are still preserved. In particular, through numerous experiments, if sort the vertices are sorted, their order is still consistent between Mₒ and Mₑ. Moreover, by merging the repeated vertices, the order will become identical too. However, the information contained in the order is not enough to represent the model. As such, the ordered vertices' IDs are used to encode the faces since the faces do not get changed. Furthermore, to eliminate the side effect of faces order, they may be sorted based on the IDs of faces' vertices. Subsequently, a sequence of faces can be obtained that are encoded by vertices IDs which do not contain any absolute coordinate numbers but rather the relationship. To have an efficient performance, the MD5 hash for the sequence can be generated and used to index the model. Any models that have the same hash will be identified as similar. Since this is an indexing based similar detection algorithm, it is fast and efficient.

Similar to static 3D models, the raw data of animated 3D models may also get changed during game development. This raw data change includes not only the shape data but also the animation data. More specifically, the changed data can be classified into the following types:
(1) The number of keyframes. Some keyframes may be dropped between Mₒ and Mₑ by the IDE tools, which might be caused by the animation optimization; and
(2) The values of keyframes (i.e., rotation and scale). The timings of the keyframes will change, which will lead to bone status data change as well.

Thus, if Mₒ and Mₑ are similar animated 3D models, their shape should be similar. Meanwhile, the skeleton between Mₒ and Mₑ are still preserved for cloned models. As such, the shape information may be first used to group the animated 3D models. Then, the skeleton information may be used to further narrow down the group. Finally, for each group, a one-to-one comparison may be performed between two suspicious models to identify the clones. One-to-one comparisons between arbitrary models are not performed due to the scalability reasons.

### Introduction to 3D Models and Meshes

At a high level, a 3D model consists of (i) a mesh that describes the basic object (including its color and texture) in a scene and (ii) the optional animation that describes how the mesh transforms its shape in different time so that the mesh can show different motions. Consequently, there can be two types of 3D models in a scene: (i) static mesh that will not move or transform such as the wall in the game, and (ii) animated mesh that can move or show with different motions such as the avatar in a game who can run, jump or walk. The following describe these meshes in greater details.

### Static Mesh

A mesh is defined by its shape and material. A shape consists of a set of vertices, edges and faces. A mesh can have thousands or more vertices. While connecting vertices, it naturally forms edges since an edge is a particular type of line segment joining two vertices. A loop connected by 3 edges (or more) represents the face that surrounded by them. And those faces together form the shape of the object represented by the mesh. For example, FIG. 1 shows an example of a mesh file. The vertices are defined from line 2 that starts with “v”. Each vertex is defined by its coordinates in x, y, z axis. The order of their definition also indicates their IDs. The faces are defined from line 7 that starts with “f”. Each face is defined by 3 vertices (also 3 edges) which is specified by its ID. For instance, the face at line 7 is defined by the third vertex, the second vertex, and the first vertex, and their corresponding x, y, z coordinates can be found at line 4, 3, and 2.

A material describes how the surface (i.e., faces) of a shape looks like (i.e., its appearance). The most common way is through color or texture. For example, a red ball can be represented by a sphere mesh with a red surface. However, the surface of an object can be very complicated with more than just a single color. To represent such objects, texture is widely used. For example, a picture of a real-world object can be projected over a mesh surface by mapping the vertices on the mesh with the picture (i.e., UV mapping). In addition, there are other attributes that can be used to describe the material such as its reflectivity and transparency.

### Animated Mesh

A mesh is not only used to represent a static object but also a movable

object like human who can walk and jump (i.e., motions). To make a mesh show different motions, the mesh needs to be a skeletal mesh that has bones, which is a common practice for mobile games. A skeleton is a set of bones that are interconnected and in a hierarchical structure (e.g., parent and child relationship). A mesh that has skeleton is also called a skeletal mesh. The vertices of a skeleton mesh are attached to the bones. And they will move by following the movement of the bones on which they attached. A child bone will move by following the movement of its parent bone. In particular, to attach vertices to a bone, there is a map between the vertices and the bone it attaches to. Similar to real world where a skin can move by several bones especially near a joint, a vertex can map to several bones and for each bone there will be a weight to indicate the degree that this bone can affect this vertex.

A motion can be presented as a series of poses, similar to a film using a series of static frames. By showing different poses sequentially, the mesh can make motions. Such series of poses is called animation and each pose is called a keyframe. One animation normally consists of a series of keyframes. A keyframe records the status of each bone at the point-in-time and the time when it should be displayed. The status includes rotation, scale and position in x, y, z axis. By moving the bone sequentially based on the time defined in the keyframes, the animation controls the movement of the mesh faces. In addition, to provide a smooth movement, a rendering tool will automatically use interpolation to generate the poses between two sequential keyframes. Eventually, it presents as a motion for the mesh.

### Creating a 3D Model

Creating a high-quality 3D model often requires not only creativity from art, but also knowledge from science and engineering such as the knowledge of biological structure and skin, and architectural finishes. While 3D model creation is a complicated task, at a high level it can be divided into the following sub-tasks:
(1) Creating shapes. The shape is the frame of a 3D model and it consists of vertices and faces. Typically, 3D design software offers some primitive shapes such as cube and ball. But for a customized object, 3D artists need to build it from scratch, or they can apply other devices such as a LIDAR scanner to scan a real object to get a corresponding mesh. The shape of a 3D object can be complicated. In an experiment detailed below, a mesh that has 2,741,574 vertices and a mesh that has 3,473,208 faces is seen.
(2) Designing appearances. One factor that determines the appearance of a 3D model is its texture. Multiple ways can be used to create the texture. For instance, a 3D artist can take a picture of a real object, and then project the picture to the mesh by connecting the vertices to the UV axis of the picture. Furthermore, to make the object look more “real”, other properties like reflectivity and transparency also need to be defined properly. There are some existing bundles of such properties. Such as “wood material” that will make the mesh surface looks like wood.
(3) Building skeletons. A skeleton is needed for a 3D model if it involves movements. To build a skeleton, a 3D artist first needs to define the number of bones and their hierarchy structure such as the bone in an arm should attach to the bone of a body. Then the artist needs to select the vertices and attach them to different bones, which is a tedious process that requires focus and knowledge such as human body structure.
(4) Designing animations. For a movable 3D object, it requires the design of animations. Simple motions like the rotation of a wheel can be easily represented by equations. For complicated motions, a 3D artist can either manually design some particular poses to generate part of the keyframes and then use interpolation to generate other frames between them, or use digital video recorder to capture a moving object in real world, from which to further generate keyframes by mapping the captured object with the bones in the 3D model.

3D model creation has become a profession. 3D artists are either employed by game producers or they work for their own by selling their 3D models in the market. There are several model markets such as CGTrader. These 3D models cover various categories such as people, animals, transportation tools, weapons, and food. In the markets, some of them are free, but most of them need to be paid. The price can go from few dollars (e.g., a pieces of log costs $2) to few thousands (e.g., a human anatomy costs $4,299). If game producers do not have dedicated 3D teams, they can purchase the needed 3D models from the market and then import into the game IDE to develop their games. When releasing the game app, the 3D models will be encoded and embedded in the game.

### Overview of 3D Clone Detection Using 3DSCOPE

In accordance with implementations of the disclosure, 3DSCOPE was developed and used to scan 3D model clones among the mobile games, by using the above two insights. When provided with a Unity-engine based mobile game, at a high level, 3DSCOPE may perform the following to detect whether there are any 3D model clones:
Extracting 3D models—3DSCOPE first needs to extract the 3D models from the game APK, and this is achieved by modifying the open-source tool AssetStudio;
Indexing 3D models—To identify similar 3D models in a robust and efficient manner, 3DSCOPE uses a value-insensitive normalization algorithm on the extracted 3D models and then index them by using the computed MD5 hashes; and
Detecting cloned 3D models—By comparing the 3D model indexes, the cloned static 3D models are identified. If they are animated-meshes models, 3DSCOPE then leverages skeleton and motion track information to further narrow down and meanwhile perform a pair-wise comparison to detect the animated cloned models.

Each of the operations above will be described in greater detail below.

### Extracting 3D Models

While 3D models can be remotely rendered by cloud platforms such as Google Stadia and displayed locally by mobile devices such as smartphones, it requires high network bandwidth and high computation power in the cloud. Therefore, most mobile games directly pack the 3D models in the APK file when compiling the games. However, since the file size for 3D models tends to be large, they are all encoded in certain ways in the APK for a smaller file size. Therefore, the 3D models are unpacked from the APK and decode the file to retrieve the 3D models.

Also, for Unity games, those 3D files are encoded by proprietary methods instead of standard ones such as ZIP. Therefore, they are decoded. Open-source tools available today (e.g., AssetStudio and UtinyRipper) may be used to extract models from Unity games. In particular, AssetStudio is a GUI tool that decodes the resource files and then exports (i.e., encodes again) the 3D models in the standard format. For example, a static 3D model will be exported to OBJ file as shown in FIG. 1 and the animated ones will be exported to FBX format. Raw data is used for the following steps and there are a large number of Unity games, so the GUI program may be modified to make it a console tool to directly produce the raw data when providing with a game APK. AssetStudio may be modified by enforcing it to directly parse models from a path specified by a command line argument. As such, it can produce the following raw data of a 3D model:
The Shape—The coordinates of the x, y, z axis of each vertex, as well as their IDs. Each face will be defined by the vertices IDs.
The Skeleton—The number of bones and their hierarchy structure using format (boneₚ, bone_{c}) to represent that bone; is attached to boneₚ.
The Animation—The list of keyframes, and each keyframe contains time, bone, rotation, translation and scale.

### Indexing 3D Models

With AssetStudio, large scale 3D models can be extracted from Android APKs. As noted above, directly hashing these models will not work so other approaches may be used. In particular, while it might be possible to apply for machine learning approaches to search for similar 3D objects, the implementations herein provide a scalable and efficient approach for the clone detection. To this end, an indexing-based algorithm is used, by which a single value will be calculated based on the raw data of the 3D model and this single value will be used to index the model. As such, the models with the same index will be identified as clones. This index-type of algorithm is efficient since the time complexity is O(1) with n 3D models. However, there are challenges in designing such an algorithm because the calculation needs to be (1) general enough, so that the cloned models with different raw data can be calculated to be the same index; (2) specific enough, so that different models can be differentiated. However, since many raw data may be changed during model import and export by the IDE tools, a normalization is needed for these raw data.

Therefore, a normalization-based indexing algorithm may be used to detect cloned models. Recall that the shape (vertices, edges, faces) consists of a lot of information about a 3D model, ideally, they should be normalized. However, as discussed above, four types of shape data may be changed between Mₒ and Mₑ: vertices values, vertices number, vertices order, and faces order caused by the Unity IDE and model extraction tools. However, the following, non-limiting, types of preserved data may be used to generate the index:
Vertices relationship—Although the x, y, z coordinates of vertices may change, the relationship between two vertices in the three dimensions are still the same in Mₒ and Mₑ. For instance, if the coordinates of X(vₐ)<X(v_{b}) in the X-axis of Mₒ, then this relationship still preserves in Mₑ.
Face numbers—To have the same visual affects, the number of faces is also consistent in Mₒ and Mₑ.
Face—vertices relationship—The vertices or face IDs may changed, but their relationship preserved. In particular, if a face fₐ exists in Mₒ, there will be a corresponding face f_{b} in Mₑ to achieve the same visual affects.

Algorithm 1 Static 3D Model Indexing

| | |
|---|---|
| 1: | Input vsₒ: the vertices in original order; ƒsₒ: the faces in original order |
| 2: | Output: hash: the hash that can represent this model |
| 3: | procedure MODELINDEXING(vsₒ, ƒsₒ) |
| 4: | vsₒᵤ ← SET(vsₒ) |
| 5: | vsₙ ← SORT(vsₒᵤ) |
| 6: | vs2ids ← DICT(Ø) |
| 7: | for i in (0, LENGTH(vsₙ)) do |
| 8: | vᵢ ← vsₙ[i] |
| 9: | vs2ids[vᵢ] ← i |
| 10: | end for |
| 11: | ƒsₙ ← Ø |
| 12: | for ƒₒᵢ in ƒsₒ do |
| 13: | ƒₙᵢ ← Ø |
| 14: | for vidₒⱼ in ƒₒᵢ do |
| 15: | vᵢ ← vsₒ[vidₒⱼ] |
| 16: | vidₙᵢ ← vs2ids[vᵢ] |
| 17: | ƒₙᵢ ← ƒₙᵢ ∪ vidₙᵢ |
| 18: | end for |
| 19: | ƒsₙ ← ƒsₙ ∪ fₙᵢ |
| 20: | end for |
| 21: | for ƒₙᵢ in ƒsₙ do |
| 22: | ƒₙᵢ ← SORT(ƒₙₛ) |
| 23: | end for |
| 24: | ƒsₙₛ ← SORT(ƒsₙ) |
| 25: | hash ← MD5(ƒsₙₛ) |
| 26: | return hash |
| 27: | end procedure |

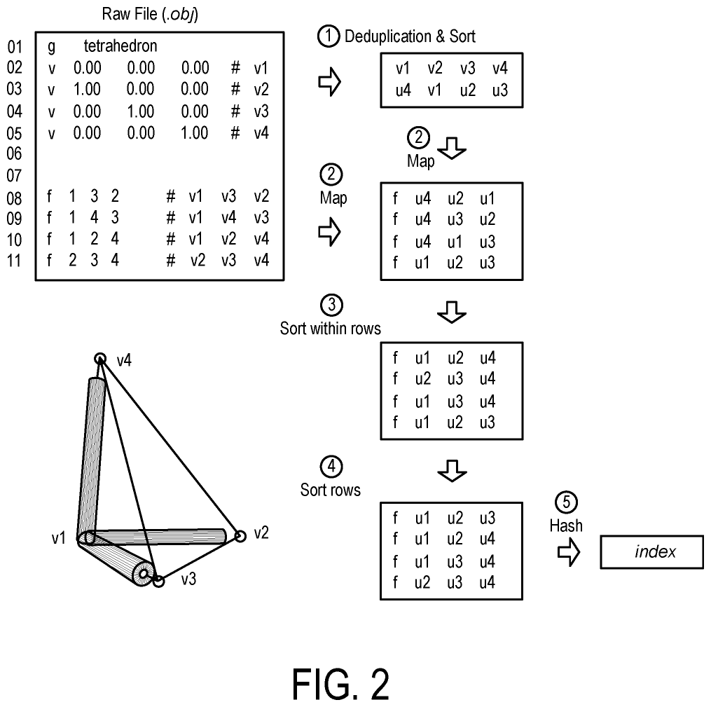

Based on those consistent data, Algorithm 1, above, will now be described. To clearly illustrate Algorithm 1, a tetrahedron model in FIG. 2 is used as a running example to show the detailed steps on how to generate its hash index. At a high level, the algorithm takes the shape information as input and outputs a hash for the model. Specifically, it first removes the duplicate vertices at line 4 by comparing the x, y, z coordinates. In the example, since there are no duplicate vertices, all the vertices will be kept. Second, the rest vertices will be sorted based on their coordinates at line 5. Each vertex will be assigned with a new ID (at line 6-10) based on its position in the sorted list. The corresponding step in the example is \textcircled{1}. The four vertices will be sorted in a descending order. As a result, the new order would be [v2, v3, v4, v1], based on which the new IDs will be assigned to them. For instance, the coordinates of v1 is ‘smaller’ than other vertices, so it is the fourth item in the sorted list. As such, its new ID is u4. Third, each face will be represented by the new vertex IDs (at line 12-20), which is illustrated in step \textcircled{2} in the example. For instance, the first face (i.e., {v1, v3, v2}) will be represented as {u4, u2, u1}. Fourth, the IDs will be sorted within the face at line 21-23, which is illustrated in step \textcircled{3} in the example. For instance, the first face (i.e., {u4, u2, u1}) will be sorted (i.e., descending) to {u1, u2, u4}. Next, the faces will be sorted based on their vertex IDs at line 24, which is illustrated in step \textcircled{4} in the example. For instance, the IDs of fourth face (i.e., {u1, u2, u3}) is ‘larger’ than any other face, so it will be sorted to the first place. Eventually, the MD5 hash value will be generated for the model by the sorted faces at line 25, which is illustrated in step \textcircled{5} in the example. Thus, the hash is not generated with any concrete coordinate values in the 3D models but rather the order of faces along with the order of its sorted vertices.

Algorithm 1, above, achieves both generality and specificity, as follows:

Generality (on Vertices). An aspect to achieve the generality is the normalization. Since the vertices' coordinates, numbers, and orders can be changed, they are each normalized. To normalize vertices' numbers, the repeated vertices can be removed in Mₑ. As such, the repeated vertices may be removed in both Mₑ and Mₒ. To normalize vertices' coordinates, since the vertices relationship is preserved, the vertices may be sorted based on their coordinates, and then use their IDs based on the sorted coordinates to represent them. In particular, for vertices vₐ and v_{b}, they will be compared based on coordinates in x, y, and z axis: If the coordinate for vₐ in x-axis is already greater than that of v_{b}, then the comparison is stopped and it is conclude vₐ>v_{b}; otherwise, a comparison is made of the y-axis, and then z-axis of needed. With the compared order of the vertices, they are sorted, from which to generate the normalized order of the vertices, as shown in step \textcircled{1} in our running example.

Specificity (on Faces). The normalized vertices do not contain enough information for model differentiation since it only has the order information. To achieve specificity, each face is represented by the new IDs of the vertices since the face-vertices relationship is preserved (e.g., the step \textcircled{2} in the running example). Meanwhile, the corresponding vertices of the faces can still be found in the ordered list once the repeated vertices get removed. There are three reasons why this approach works. The first is that the 3D models are complex which means they have a considerable amount of faces; the second is that the number of faces are preserved in Me; and the third is that the representation is complex enough since each face will be represented by its vertices IDs. Then to normalize the face order, the vertices IDs are sorted within each face (e.g., step \textcircled{3} in the running example) and sort the faces based on its vertices IDs (e.g., the step \textcircled{4} in the example). Eventually, the sorted sequence of faces can be used to represent the model. To get a better performance, the MD5 hash is generated for the sequence and use it as the final value to index the corresponding 3D model (e.g., the step \textcircled{5} in the example).

### Identifying Cloned 3D Models

The purpose of 3D model indexing is for identifying the cloned static 3D models. In particular, indexing is based on the shape, which is the basic element of both static 3D models and also animated 3D models. By comparing the indexes of the 3D models, the cloned static 3D models can be directly identified. More importantly, this index can also significantly help identify the animated 3D models, since the same shape may be used to narrow down the “suspicious” cloned animated 3D models. That is, 3DSCOPE directly detects static 3D models, whereas to detect animated 3D models, it uses static 3D model detection first to narrow down the scope (for efficient reasons) and then performs a pair-wise comparison.

Detecting Cloned Static 3D Models. If a model does not contain any animation, it is a static 3D model. The index value computed above can now be directly used to detect static model clones. That is, if any two models have the same index value, then 3DSCOPE decides one of them is a clone of the other. Also, since one model may be cloned by several games, 3DSCOPE automatically groups the 3D models based on their indexes. To detect the original one among the cloned one, techniques such as 3D watermarking may be used.

Detecting Cloned Animated 3D Models. An animated 3D model is composed of the static 3D model, the skeleton, and the animation. Similar to our static 3D model clone detection, an indexing-based approach for animated models may be used. However, detecting animated 3D model clone is more complicated than that of the static 3D model, as the shape alone cannot be used (i.e., static 3D models) for the detection, because an animated 3D model contains animations and meanwhile the animation is applied on the skeleton (but different animated 3D models can have the same skeleton). Particularly, although the skeleton does not get changed, the animation information has changed in several ways (more details will be provided below). Instead, a divide-and-conquer algorithm may be used, by which the animated 3D models are first divided into groups, and then conquer the clone detection within each group with a pair-wise comparison.

Dividing animated 3D models by its static 3D model and skeleton. In addition to the static 3D model, the skeleton can also be used to divide the animated 3D models since a cloned copy must have the same skeleton. As discussed in above, a skeleton is a set of bones constructed in a hierarchy structure in which a bone is attached to another. The hierarchy structure of the bones are following the same structure of the target object such as humans bones, for instance, the left foot bone is attached to left leg bone. The head of the hierarchy structure is the root bone. Since a skeleton is essentially represented in a tree structure, Algorithm 2 to index the skeleton as well is described below.

Algorithm 2 Skeleton Hashing

| | |
|---|---|
| 1: | Input: bone: the root bone of the skeleton |
| 2: | Output: hash: the hash that can represent this skeleton |
| 3: | procedure SKELETON HASHING(bone) |
| 4: | boneₛ ← Ø |
| 5: | for child in CHILDRENBONES(bone) do |
| 6: | childₛ ← SKELETONHASHING(child) |
| 7: | boneₛ ← CONCAT(boneₛ, childₛ) |
| 8: | end for |
| 9: | hash ← MD5(boneₛ) |
| 10: | return hash |
| 11: | end procedure |

In particular, Algorithm 2 is a recursive algorithm. A hash value will be used to represent each bone, and the hash value for the root bone will be used to index the skeleton. The hash value of a bone is based on the hash values of its children's bones (i.e., line 6). In particular, the hash values of children bones will be concatenated as shown in line 7, and the MD5 hash function will be applied on the concatenated results to generate the hash for parent bone (i.e., line 9). As shown at line 4, if the bone has no children, its value will be the MD5 hash of the empty string. As such, the process is able to index skeletons and further narrow down the animated 3D models into groups. Specifically, to group animated 3D models, any models that have the same static 3D model and skeleton will be divided into the same group.

Conquering the clone detection via pair-wise comparison. Among each identified group of the “suspicious” animated 3D models clones, a pair-wise comparison is used to finally decide the clones. However, this is a challenging task since every type of the raw data in an animation could have been changed. In particular, an animation is a list of keyframes that show at different timing points, and each keyframe contains its timing point and a list of bone statuses which contain the rotation and scale information for the bone that needs to perform in this particular keyframe. The rotation and scale information contains the angle of rotation, translation and scale value in x, y, and z axis. With the bone status information for different keyframes, the rendering platform will apply interpolation to predict the bone statuses between the keyframes, so that it can present a smooth motion.

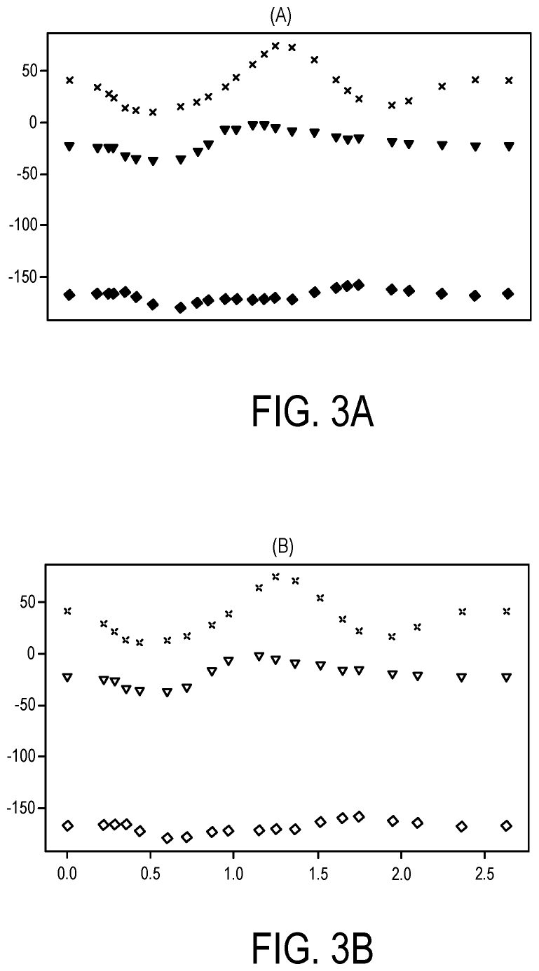

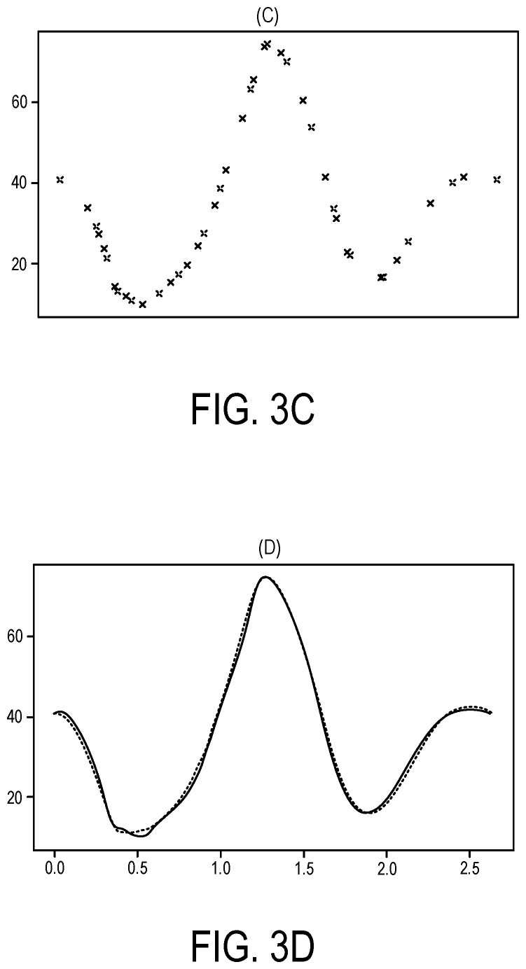

When focusing on a specific bone during the animation, it can be shown in a scatter plot over time (the horizontal-axis) and rotation (the vertical-axis), and the status information are scattered data points in this plot. FIG. 3A presents the rotation information of the leftUpLeg bone in a walk animation for a human-like model Mₒ. The horizontal-axis is time and vertical-axis is the rotation angles of the bone in the 3D (represented by x, y, z coordinates). For example, at timing point 0 (i.e., initial state), the bone should rotate 40.83 in x-axis in the 3D, −23.27 in y-axis, and −166.77 in z-axis. FIG. 3B is the data of the same bone in the Mₑ. It can be seen that the data have changed dramatically. Specifically, (1) the timing point has changed. For example, the second timing point in Mₒ is 0.17, however, the second timing point in Mₑ is 0.22; (2) the values of rotation angle have changed. Similar to the shape data, the absolute values of the rotation angle have changed; (3) the number of keyframes has changed. There are 25 keyframes in Mo, but only 19 keyframes in Mₑ.

Therefore, to compare these two animations, it is impractical by simply comparing their keyframes one by one, since the timing point of each keyframe has changed, they could not be aligned. Since the animation is a motion applied on a set of bones, by following the principle of divide-and-conquer again, the process may first compare the movement similarity of the same bone in two animations, then calculate an average similarity based on the similarity of all bones' movements. With such an average similarity, similar animations are clustered into groups.

Next, to compare the movements of the same bone in two animations, since the movements contain the rotation, translation and scale data in x, y, and z-axis (9 types in total), they are divided further. In particular, they may be compared one by one (i.e., x to x, y to y) and then merge them together by calculating the average value. More specifically, the rotation data in x-axis of the bone in two animations is first compared, then compare other eight types of data. An average similarity based on them is calculated. When focusing on one specific comparison, such as the rotation angles in x-axis as presented in FIG. 3C in which the leftUpLeg bone's x rotation angles of both Mₒ (i.e., in red) and Mₑ (i.e., in blue) is included. It can be seen that such data are two sets of scattered data points. Even though the comparison is divided to such a low level, it is still challenging to compare the scattered data points.

For each of the scattered data points set, a curve is determined that crosses the points. Then two curves for the two data point sets are obtained, for example, FIG. 3D shows the two interpolation curves of the data in FIG. 3C. As such, the similar comparison of the two sets of scattered data points has been transformed to similar comparison of two curves.

There are several algorithms for curve similarity calculation, such as Euclidean distance (ED), Dynamic Time Warping (DTW), and Longest Common Subsequences (LCSS). Euclidean distance may be used for this purpose. An example formula is:

$$\frac{1}{n} {\sum }_{k = 1}^{n} \vert {curve}_{o} ( {x}_{k} ) - {curve}_{e} ( {x}_{k} ) \vert$$

With n samples on the x coordinates, for each of the samples, the distance of the corresponding values on the two curves is calculated. The average distance is the curves distance. In particular, assume xₖ is the kth sample, curveₒ(xₖ) returns the corresponding angle value of xₖ on the curve of Mo. With this, it will produce the Euclidean distance of the two curves. Specifically, 100x coordinates may be sampled for the calculation. For each sample, the Euclidean distance is calculated, for example when time=0.5 (i.e., x=0.5), the rotation angles of Mo is 11.11 (i.e., curveₒ(x=0.5) and Me is 9.76. As such, the Euclidean distance is 1.35 (at time=0.5). Then the final Euclidean distance will be calculated by averaging the Euclidean distance of the 100 samples.

To put it all together for the clone detection of the animated 3D based on the static index, the ED of each type of data of one bone's movements is first calculated. Second, by averaging the ED, the ED of one bone's movements is calculated. finally, by averaging such value for all bones, the ED of the two animations is then calculated. The animations will be identified as clone if the ED is smaller than a threshold T. To find an optimal T, 100 animations are selected and cloned them. With experiments on the 200 animations, the threshold was determined to be 0.95.

### Evaluation

Thus, as described above, the present disclosure provides an understanding of 3D model clones, for example, in Android mobile games. A similar understanding may be applied to iOS mobile games as well. Games created by the Unity engine are described because extracting the 3D models from the games uses a GUI-based engine specific 3D model extraction tool (e.g., AssetStudio for Unity games, or UE Viewer for Unreal Engine) to automatically extract the 3D models, and Unity is a leading game engine.

As describe above, 3D model clones are detected (i.e., a close to exact copy of the original one), rather than detecting an altered copy of the original 3D models. However, the implementations herein may detect certain changes to the original, such as squashing or stretching. While this may lead to certain false negatives, this is reasonable for a proof-of-concept (i.e., presenting a lower-bound estimate on the scale of the cloned 3D models in mobile games), because it is a challenging task to have a sound algorithm to detect the altered clones since the altering is hard to quantify. To really detect such unauthorized and altered clones, other techniques such as 3D watermarking may be used.

### Experiment Setup

Dataset. To understand the 3D model clone in Android apps that developed with Unity, we need to collect all the apps first. To collect the apps on Google Play, we have developed a crawler based on the Scrapy framework to obtain all the app package names in August 2021. Since the apps that contain 3D models usually are games, we focus on game categories, and in total 315,321 games have been found. Then we used gplaycli to download the APK files from Google Play server by interacting with its private Web APIs. In total, 315,321 mobile games have been collected. Next, we identified the games that developed with Unity by checking the magic number of the files located in assets folder in each APK. Eventually, we have identified 176,361 Unity based games which take 5TB of hard drive space to store.

Environment. We run the experiment on a Dell server that has dual Intel Xeon 8268s CPUs (48 cores @2.9 GHz per CPU), 192 GB memory and 96 TB hard drive. The operating system is Red Hat Enterprise Linux (RHEL version 7.9). Since the AssetStudio is developed with C #which requires .NET environment, we use the Wine framework to run it on RHEL. In particular, we use Wine64 to support it. To quantify the overhead introduced by Wine64, we have conducted some experiments, and found that there is 10% overhead of running AssetStudio on Wine64 comparing to run it natively on Windows, which is acceptable.

TABLE I
The 3D models distribution across game categories.

| Game Category | # Games | # Static | # Avg. | # Animated | # Avg. |
|---|---|---|---|---|---|
| Action | 13,622 | 3,628,174 | 266.35 | 2,050,971 | 150.56 |
| Adventure | 6,737 | 1,931,868 | 286.75 | 835,033 | 123.95 |
| Arcade | 14,829 | 2,480,407 | 167.27 | 634,569 | 42.79 |
| Board | 1,278 | 85,320 | 66.76 | 33,072 | 25.88 |
| Card | 670 | 40,021 | 59.73 | 38,394 | 57.30 |
| Casino | 793 | 42,234 | 53.26 | 56,662 | 71.45 |
| Casual | 12,176 | 2,331,971 | 191.52 | 705,614 | 57.95 |
| Educational | 2,447 | 541,045 | 221.11 | 171,626 | 70.14 |
| Music | 726 | 55,419 | 76.33 | 27,862 | 38.38 |
| Puzzle | 6,749 | 1,312,079 | 194.41 | 466,566 | 69.13 |
| Racing | 6,745 | 2,554,523 | 378.73 | 243,820 | 36.15 |
| Role Playing | 3,258 | 1,069,659 | 328.32 | 539,948 | 165.73 |
| Simulation | 13,135 | 5,270,549 | 401.26 | 1,272,250 | 96.86 |
| Sports | 3,249 | 553,301 | 170.30 | 264,845 | 81.52 |
| Strategy | 2,304 | 546,875 | 237.36 | 307,952 | 133.66 |
| Trivia | 412 | 51,594 | 125.23 | 25,274 | 61.34 |
| Word | 389 | 22,322 | 57.38 | 22,343 | 57.44 |

### Experiment Results

Results overview: We have tested 3DSCOPE with the 176,361 Unity based games. To accelerate the analysis, we run 80 instances in parallel for extracting and indexing the 3D models. The experiment took our server 125 hours for analysis. As a result, 3DSCOPE found 89,519 of the games contain 3D models, and it found 22,517,361 static 3D models and 7,696,801 animated 3D models, which indicates that each app has 251.54 static 3D models and 85.98 animated 3D models on average. Meanwhile, within a game, the same model can be used for several times which can be identified by the resource file that the model used. By removing the repeated models within each game, we found 12,200,055 static 3D models and 2,451,304 animated 3D models eventually. With our 3D model indexing algorithm, 3DSCOPE identified 5,557,146 distinct static 3D models. The models can have up to 2,741,574 vertices (which is a model of courtyard in game Restoration VR) and 3,473,208 faces (which is a model of corona virus in game Lockdown Area). By identifying similar 3D models among the static 3D models by their indexes, 3DSCOPE found that 4,510,514 only exists in one game and 1,046,632 (i.e., 18.83%) have been found in different games. More than 94.75% of games that have used cloned models. The most popular 3D model is a model of floor which only has 4 vertices and 2 faces. It has been found in 29,176 games. In addition, there are 41,322 distinctive skeletons across all the animated 3D models. By combining model index and skeleton, there are 188,015 groups of animated 3D models. By comparing the animations within each group, 1,722,795 distinct animated models have been identified. Among them, the most popular animated 3D model is a model of a driver with animation turnSteeringWheel which has been found in 1,544 games.

Results in details: To present clearly the experiment details of how 3DSCOPE performs with these games, since there are three components inside 3DSCOPE, we present how each component performed in the following.

Extracting 3D models. Again, in total 3DSCOPE extracted 12,200,055 static 3D models and 2,451,304 animated 3D models. However, we also found that, not all of the Unity based games contain 3D models, because there are many 2D games.

In total, we found 89,519 of them contain 3D models. The 3D model numbers are varied among different game category. As such, we present the models information based on the game category in Table I. We can see that Simulation game category is the top category that contains more 3D models. Meanwhile, on average, the games in Simulation category also contains more 3D models. One possible reason is that, this type of games is commonly simulating real-word activities (such as vehicle simulation) which require more models than other game categories. For animated 3D Models, the Action category contains more than other categories. However, on average, the Role Playing category contains more animated 3D Models than other categories. It indicates that the games in Action category would use the same animated 3D Models for several times and the game in Role Playing category needs more different kinds of animated 3D models. In addition, we also present the model information by grouping the games based on the installed times in the first 6 columns in Table II. We can see that, popular games tend to use more models (i.e., column 4, 6 are increasing) for rich content.

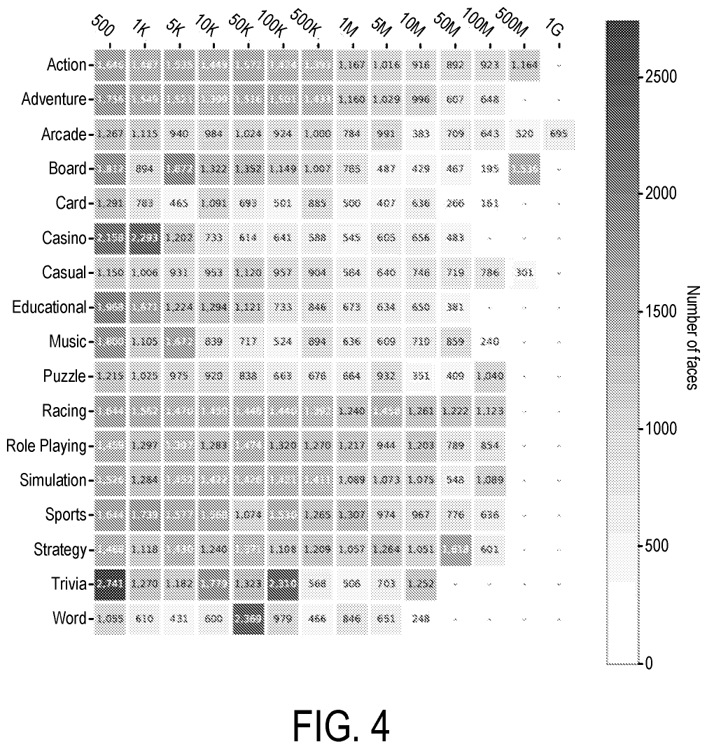

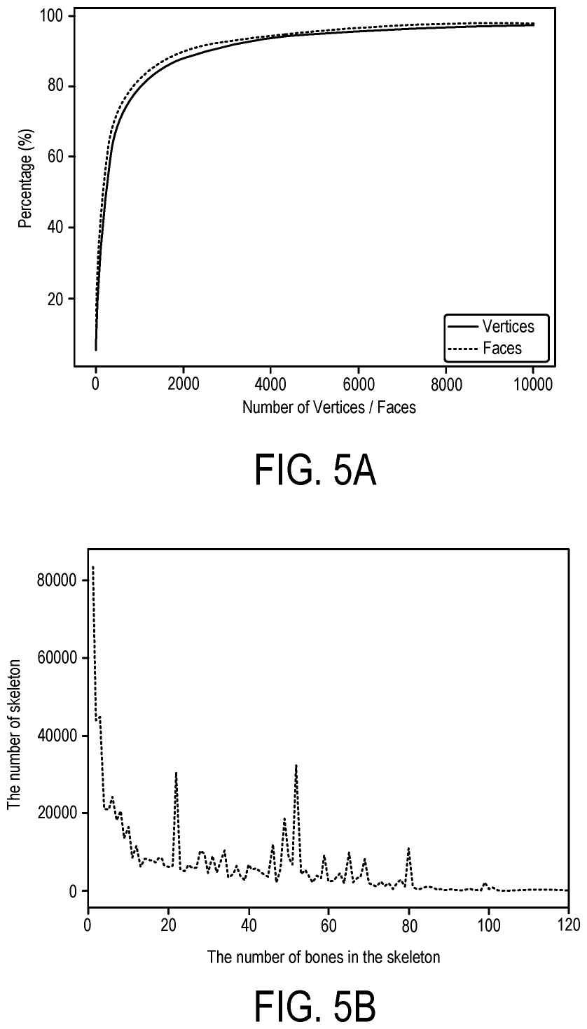

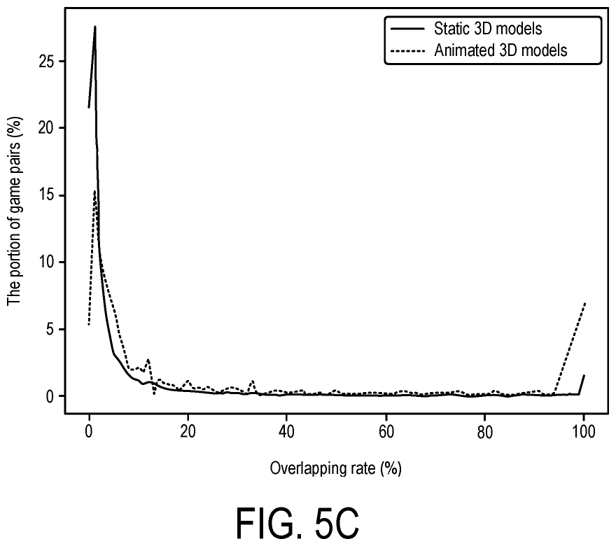

Indexing 3D models. To understand the complexity of the 12,200,055 static 3D models for the indexing algorithm, we present the distribution of the shape information in FIG. 5A. In particular, the horizontal-axis is the number of vertices (for red curve) and faces (for blue curve); the vertical-axis is the percentage of 3D models that have less vertices or faces than the corresponding value in the horizontal-axis. We can see that more than 20% of models have more than 1,000 vertices and there are even some models (i.e., 2.52%) have more than 10,000 vertices. Similarly, 80% of models have more than 820 faces and there are even 2.30% of models have more than 10,000 faces. Meanwhile, we also present the average vertices and faces data for games with different install numbers in columns 7 and 8 of Table II. Interestingly, while the popular games tend to have more models, the model complexity is actually decreasing (i.e., column 7, 8 are decreasing). To clearly show this finding, we present a heat map of the average faces distribution of games based on their categories and install numbers in FIG. 4. We can see that, the models in some categories (e.g., Action) are more complex than others. Meanwhile, in all the categories, the trend of model complexity is decreasing while install number is increasing.

We also present the distribution of the extracted skeletons, which can be found in FIG. 5B. The x axis is the number of bones the skeleton has, and the y axis is the number of such skeletons. We can see that most skeletons have less than 100 bones. But the skeleton can also be complex, the most complex skeleton in the experiment has 979 bones which is a pant that has motions in game Misguided.

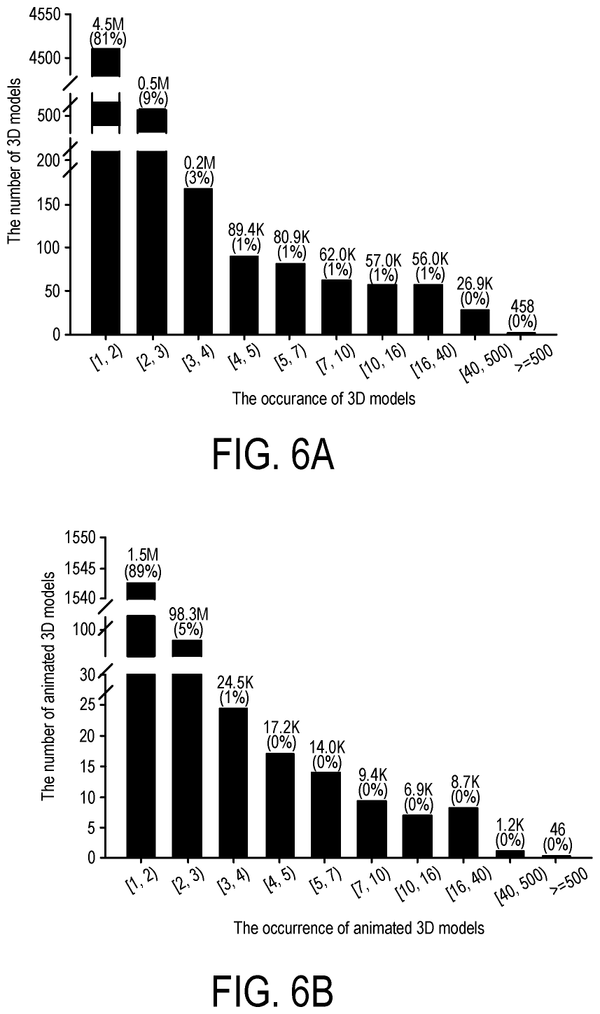

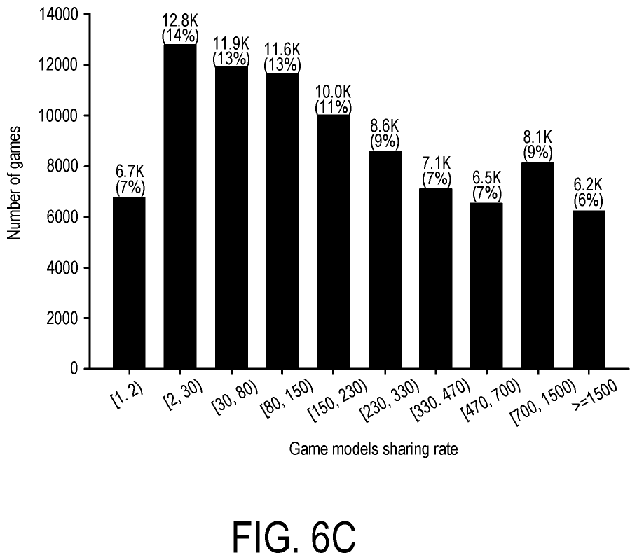

Identifying Cloned 3D Models. After our indexing, 3DSCOPE is ready to detect the clones. In total, 5,557,146 distinct static 3D models have been identified. 1,046,632 of them have been found in different games. The column 9-13 presents the experiment data for this component. We can see that, popular games tend to contain more cloned models (i.e., the last column is increasing). To understand the static model clones, we further group the models based on the number of games that contain them (i.e., the model occurrence) and present the data in FIG. 6A. We can see that 4.5 million of them only exist in one game and 0.5 million of them exist in two games. And more than 530,000 of them exist in more than 2 games. There are even 458 models that have occurred in more than 500 games. As such, more than 80% distinct models are exclusive models (i.e., only exists in one game). In addition, to understand the model clone among games, we define a term sharing rate (i.e., sr) for each game which can measure its clones of the models. In particular, sharing rate is the average occurrence of all its models, which can be calculated by the following equation:

$${sr}_{G} = \frac{1}{n} {\sum }_{k = 1}^{n} occurence ( {M}_{k} )$$

The occurrence (Mₖ) can get the occurrence of model Mₖ. By grouping the games based on their sharing rates, we create FIG. 6C. We can see that only around 6,700 games' sharing rate is 1.0, which means all their models are exclusive. Please recall that 80% models are exclusive. As such, there are some common models that being used by many games.

Finally, by grouping the animated 3D models by its static model index and skeleton, 3DSCOPE identified 188,015 groups of animated 3D models. With further comparison, 1,722,795 distinct animated 3D models have been identified. They are using 179,541 static 3D models. On average, each model can have around 10 motions. Similar to static model clone, we present the data of animated 3D models clone in FIG. 6B. We can see that 1.5 million (i.e., more than 88%) animated 3D models only exist in one game. Most of them (i.e., 94%) are exist in on or two games. Therefore, we can conclude that static 3D model clone are more common than animated model clone. However, similar to static 3D model clone, there are some popular animated models, for instance 46 animated 3D model occurred in more than 500 games.

False positive (FP) and false negative (FN) analysis. 3DSCOPE may generate FP and FN since there are some information lose during model indexing. To quantify the FP (i.e., different models being identified as similar), we have randomly selected 50 none-exclusive static 3D model index and 50 groups of none-exclusive animated 3D model groups. In total, we collected 461 static 3D models and 240 animated 3D models. By manually reviewing the models, from the perspective of appearance, we did not find any models that are different but with the same index. While the FP can be quantified, it is hard to quantify the FN (i.e., similar models with different indexes). We take advantage of the name field of the model which can be defined by the developers. In particular, we manually collected a list of 50 common object words including ‘bike’, ‘dog’. Then for each word, we collect 10 models whose names contain the word. Then we manually review the models for each word. The result is that we did not find similar models that has different indexes. That is, we did not have the FN at least for the model we validated.

TABLE II
The 3D models distribution across games that grouped by their install times.

| | | (I) | | | | | |
|---|---|---|---|---|---|---|---|
| | | | | Animated | | (II) | |
| | # | Static 3D Models | | 3D Models | | Model Average | |
| # Installs | Games | Total | Average | Total | Average | Vertices | Faces |
| 500 | 33,182 | 4,969,430 | 149.76 | 1,357,767 | 40.92 | 1,766.91 | 1,470.54 |
| 1K | 13,177 | 2,948,531 | 223.76 | 919,989 | 69.82 | 1,612.37 | 1,325.13 |
| 5K | 5,475 | 1,392,774 | 254.39 | 429,659 | 78.48 | 1,646.80 | 1,341.39 |
| 10K | 11,659 | 3,389,492 | 290.72 | 1,249,804 | 107.20 | 1,630.57 | 1,320.78 |
| 50K | 4,528 | 1,468,631 | 324.34 | 540,708 | 119.41 | 1,729.43 | 1,378.50 |
| 100K | 9,460 | 2,998,522 | 316.97 | 1,161,467 | 122.78 | 1,613.92 | 1,318.86 |
| 500K | 3,457 | 1,265,555 | 366.08 | 446,742 | 129.23 | 1,592.51 | 1,309.02 |
| 1M | 5,521 | 2,323,020 | 420.76 | 796,189 | 144.21 | 1,277.82 | 1,040.69 |
| 5M | 1,313 | 663,554 | 505.37 | 234,583 | 178.66 | 1,291.44 | 1,038.19 |
| 10M | 1,448 | 890,168 | 614.76 | 473,049 | 326.69 | 1,000.09 | 825.86 |
| 50M | 202 | 152,370 | 754.31 | 60,573 | 299.87 | 853.12 | 756.63 |
| 100M | 89 | 51,016 | 573.21 | 23,896 | 268.49 | 923.47 | 838.93 |
| 500M | 7 | 2,934 | 419.14 | 1,989 | 284.14 | 760.56 | 702.61 |
| 1B | 1 | 1,364 | 1,364.00 | 386 | 386.00 | 730.06 | 695.31 |
| | | | (III) | | | | |
| | | | Distinct Model | | Model Clones | | |
| | | # Installs | Static | Animated | Static | Animated | Average |
| | | 500 | 1,404,839 | 338,742 | 409,252 | 72,485 | 14.52 |
| | | 1K | 918,647 | 198,108 | 398,695 | 62,881 | 35.03 |
| | | 5K | 515,873 | 114,060 | 241,060 | 35,022 | 50.43 |
| | | 10K | 1,033,665 | 247,982 | 452,565 | 68,981 | 44.73 |
| | | 50K | 486,907 | 137,904 | 264,041 | 33,113 | 65.63 |
| | | 100K | 949,642 | 226,499 | 428,137 | 67,664 | 52.41 |
| | | 500K | 476,733 | 133,743 | 242,269 | 37,844 | 81.03 |
| | | 1M | 961,134 | 371,945 | 350,072 | 43,033 | 71.20 |
| | | 5M | 285,578 | 88,566 | 122,666 | 16,824 | 106.24 |
| | | 10M | 483,649 | 131,387 | 174,879 | 25,898 | 138.66 |
| | | 50M | 77,433 | 12,977 | 29,382 | 1,798 | 154.36 |
| | | 100M | 37,040 | 5,664 | 10,367 | 364 | 120.57 |
| | | 500M | 2,271 | 123 | 243 | 0 | 34.71 |
| | | 1B | 1,048 | 376 | 316 | 10 | 327.00 |

Thus, the embodiments of the present disclosure may be implemented in 3DSCOPE and applied to detect 3D model clones among, e.g., Unity-engine based mobile games crawled from Google Play. 3DSCOPE successfully extracted 12,200,055 static 3D models and 2,451,304 animated 3D models from these games. With these 3D models, 3DSCOPE has identified (i) 63.03% static 3D models are cloned models that are derived from 1,046,632 distinct models, and only 36.97% static 3D models are exclusive models that only exist in one game; (ii) 37.07% animated 3D models are clones that derived from 180,174 distinct models, and 62.93% animated 3D models are exclusive models.

### Case Study—Detecting Unauthorized Clones

Although we have identified 1,046,632 static 3D model clones and 180,174animated 3D model clones, it is challenging to decide whether the clone is an illegal clone (i.e., unauthorized clones) or not, since developers could have purchased them from the markets. The key difference of legal and illegal is that whether the clone is agreed by the creator, and it is unrealistic to detect illegal clone only with the data of models. By manually reviewing thousands of model clones we found that (1) if a model can be purchased, it would normally be purchased by several developers. As such, several games will contain the same model. (2) Popular games developers tend to create their own models instead of purchase. (3) Since popular games attracted more attentions than none-popular games, their models are more likely to be stolen than the models in none-popular games. (4) The complex models (i.e., has more than 200 vertices) are more likely to be stolen than simple models. With these observations, we propose a heuristics to find the potential unauthorized clones: if we find some com plex models only exist in a popular game and a non-popular game from a different developer, it is very likely that the none popular game stolen the models from the popular game.

In particular, (1) we first find the complex static and animated 3D models that shared by two games. (2) We filter out the pair of games that from the same developers based on the developer information on Google Play. (3) Only the pairs that contain a game that has more than 1 million installs and a game whose installs are 1% of the other game will be kept. Eventually, we located 6,850 pairs of games for static 3D model clones and 817 pairs of games for animated 3D model clones that are potentially unauthorized clones. Among the two sets of pairs, 265 pairs have been found in both sets. To understand the clones within each pair, we define an overlapping rate between two games (Ga and Gb) as:

$$overlapping ( Ga , Gb ) = \frac{{MS}_{GA} ⋂ {MS}_{Gb}}{{MS}_{GA} ⋃ {MS}_{Gb}}$$

MS_{Gb} is the models in game Gb. We present the distribution of the overlapping rate of game pairs in FIG. 5C. We can see that, most of them have overlapping rate of less than 20%, which indicates that only part of the models in one game have been stolen by another game. Meanwhile, there are spikes around 100% overlapping rate. To further understand the spike and the clone behaviors in the pairs, we have manually reviewed the overlapping models in hundreds of pairs, and obtained the following three reasons for the model clones.

Game Clone. An attacker can repackage an existing game for purpose such as distributing malware or monetization by replacing advertisement revenue account in the game. Then the attacker uploads it to Google Play. The original game and the repackaged game would have a very high (i.e., around 100%) overlapping rate. The spikes around 100% overlapping rate in FIG. 5C are caused by such game clones. Please note that, due to the upgrading of original game, their overlapping rate may not be 100% exactly. Table III presents the top 5 game clones in the identified pairs. We can see that, some repackaged games have been uploaded to different game category from the original category. It maybe because the attackers are trying to avoid the games from being recognized by the original developers.

Idea Clone. The original developer created a popular game with a brilliant idea and then the attacker would try to reproduce the idea by making a similar game. When creating this game, the attacker may steal some models from the original game. Table III presents 5 such cases. For example, Join Clash 3D is a popular game (i.e., has more than 100 million installs) that user should try to take control of the castles. Its logic and scheme are distinctive. However, we found another game Join Clash 3D: Crowd Rush (with 5K installs) which offers similar content but with lower overall quality. It has 8.84% (i.e., 67 models) static model overlapping rate and 11.59% (i.e., 8 models) animated model overlapping rate with the original game.

Model Clone. The attacker may just have interest on some models used in one game and decide to steal and use them in his or her own game. We show 5 such cases at the last 5 row of Table III. For instance, we found that the game Subway Surfers (very popular game) and Bob the robber Runner (none-popular game with 1K installs) share one model of a dog whose shape is very special and we did not find it in the market. It is very likely that the model in Subway Surfers has been stolen.

To confirm our findings, we have contacted all the developers of both popular games and none-popular games. Positive responses have been received from popular games but no responses from none-popular games at the time of writing this paper. For instance, the developers of Transit Drift & Driving Simulator has confirmed that game Grand City Car Driving is cloned from their game.

### Related Applications and Use Cases

Detection beyond mobile games. While 3DSCOPE is described as focusing on mobile games 3DSCOPE may be used for other games. Note that 3D models are not just in computer games, they are everywhere today in such as movies, TV shows, medical images, and manufacturing designs (e.g., for designing mechanical parts), and 3D printing. Identifying 3D model clones in these industries is an interesting research direction too.

There has been a growing interest of the metaverse, in which users can experience, explore, and interact with their virtual 3D world, or worlds, through a wide range of devices including smartphones, tablets, and headsets. Undoubtedly, 3D models will be a key asset in the metaverse. How to protect the 3D models from being stolen, detect their clones, will be an important research topic.

Detecting illegitimate clones. 3DSCOPE only detects cloned 3D models, and cannot conclude the origins of the model (or the legitimacy of the clone). A difference between legal and illegal clone of the 3D model is whether the clone is agreed by the model creator. It may be difficult to detect illegal clones exclusively based on the available data in the 3D model, unless there are watermarking inside or any other information that can be leveraged such as the heuristics we have drawn in our case studies. We leave the integration of watermarking type of techniques for future work.

Using machine learning algorithms. 3DSCOPE uses an indexing-based approach to directly detect static 3D model clones based on the hash values. It assumes there is no significant modification of the 3D models. Certainly, other approaches such as the pattern recognition algorithms using the artificial neural networks could be applied to detect 3D model clones. More specifically, the features 3DSCOPE has derived are very basic (e.g., order of vertices, sequences of faces), and there could be more representative features from the 3D geometry, e.g., those used in 3D shape retrieval, and also use machine learning to automatically derive representative features.

Game security and analysis. Computer games have become one of the largest entertainment industries. A key theme in game security has always been cheating and anti-cheating, where game cheaters exploit weaknesses in game design, distribution, and execution, and game defenders leverage various patterns (e.g., inconsistency) from cheating and recently secure hardware (e.g., SGX as in Black-Mirror) to defend against cheats. Particularly for mobile game security, various cheats such as the modification of memory and network traffic, and also provided a reference framework for the mobile game defense.

3D model watermarking. To track the provenance and detect illicit copies, 3D model watermarking, which covertly embeds a hidden piece of information in the original 3D models. Over the years, numerous improvements have been proposed, such as authentication watermark, forensics tracing watermark, and biometric watermarks. Certainly, using stereographic projection for 3D object classification and retrieval is a viable approach for clone detection, particularly on tracing the origins. 3DSCOPE complements with these works by detecting clones without watermarking.

3D model clone study. For a different goal, 3D model clone has been well studied in crowd simulation, in which a large number of diversified individual 3D object needs to be generated. Any clone of these 3D models or motions would degrade the player's experience. As such, visual variety and context-aware motion diversification have been proposed to solve these problems. Compared to these works, 3DSCOPE focuses on a completely problem.

### Conclusion

Thus, a practical application of the present disclosure, the 3DSCOPE tool to scan 3D model clones in mobile games is described herein. Given a large volume of 3D models we have to process, 3DSCOPE employs a number of efficient and robust techniques such as value-insensitive normalization algorithm to normalize the 3D models. Our evaluation results with 176,361 mobile games show there are 12,200,055 static 3D models and 2,451,304 animated 3D models in these games. With these 3D models, 3DSCOPE has shown that 63.03% of static 3D models are cloned and they are derived from 1,046,632 distinctive models, and 37.07% of the animated 3D models are cloned and they are derived from 180,174 distinctive models. While common 3D models are one of the reasons for these clones, there are indeed unauthorized copies among them such as using game clone, idea clone, and model clone, as detected from our heuristics-based approach. In addition to improve the precision (e.g., for less false negatives), our future work will plan to identify these unauthorized copies more systematically by combing other techniques such as those from machine learning and 3D model watermarking.

Thus, the present disclosure describes methods and systems that detect 3D model clones in mobile games at scale and provides practical techniques to detect the clones by indexing the static 3D models with a value-insensitive normalization and aligning the animated models by measuring the Euclidean distance using the interpolation of motion tracks. The empirical results show that the implementations of the present disclosure determined that that 63.03% of static 3D models and 37.07% of animated 3D models are clones. With a heuristic-based unauthorized clone detection, 3DSCOPE detected 7,402 potentially illegal clones as shown in the case study.

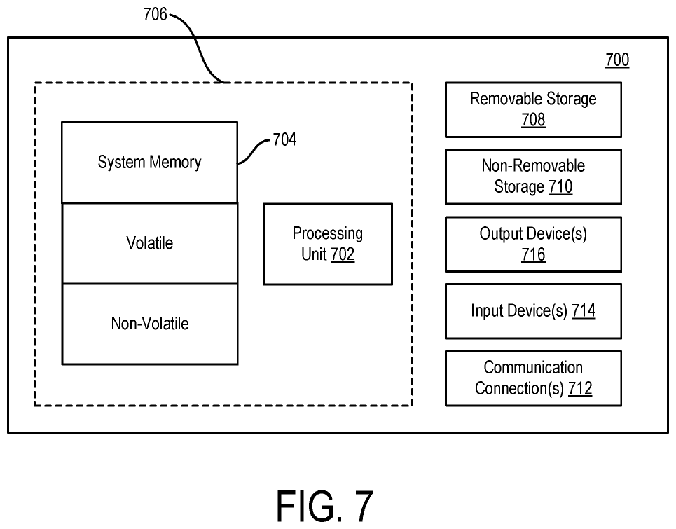

FIG. 7 shows an example, non-limiting, computing environment in which example embodiments and aspects may be implemented. The computing environment is only one example of a suitable computing environment and is not intended to suggest any limitation as to the scope of use or functionality.

Numerous other general purpose or special purpose computing devices environments or configurations may be used, such as, but not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include tangible volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

In one or more implementations, the operational flows of FIGS. 2A, 2B, 6A, 6B, 7 and 8 may be implemented in a computing environment such as that shown in FIG. 7. Further, the complex numerical computations to determine the unique hashes, the storage of data fragments, and other data operations described herein may be performed in a computing environment such as that shown in FIG. 7.

As used herein, the singular form “a,” “an,” and “the” include plural references unless the context clearly dictates otherwise.

As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

It should be understood that the various techniques described herein may be implemented in connection with hardware components or software components or, where appropriate, with a combination of both. Illustrative types of hardware components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, IoT and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of detecting 3D clone in a game, comprising:
extracting 3D models from a game file;
using a value-insensitive normalization algorithm on extracted 3D models and indexing the extracted 3D models using a computed hash value to create 3D model indexes;
and comparing the 3D model indexes to identify cloned static 3D models.

2. The method of claim 1, further comprising using skeleton and motion track information to perform a pair-wise comparison to detect animated cloned models.

3. The method of claim 1, further comprising decoding the game file to extract a static 3D model to an OBJ formatted file, and to extract 3D models to an FBX formatted file.

4. The method of claim 1, wherein extracting the 3D models from the game further comprises producing raw data of the 3D models that includes a shape, a skeleton and animation of the 3D models.

5. The method of claim 4, wherein the shape comprises coordinates of the x, y, z axis of each vertex and their IDs.

6. The method of claim 4 wherein the skeleton comprises a number of bones and their hierarchy structure using a format (boneₚ, bone_{c}) to represent that bone_{c} is attached to boneₚ.

7. The method of claim 4, wherein the animation comprises a list of keyframes, wherein each keyframe contains time, bone, rotation, translation and scale.

8. The method of claim 1, wherein indexing the 3D models further comprises generating a single value for each of the 3D models based on the raw data of the 3D model.

9. The method of claim 8, further comprising using the single value to index the 3D model, wherein the 3D models with a same index are identified as clones.

10. The method of claim 9, wherein the index is determined based on a relationship of the vertices, face numbers, and a face-vertices relationship.

11. The method of claim 10, wherein the relationship of the vertices in the three dimensions is the same in Mₒ and Mₑ, wherein assume Mₒ denotes the original 3D model and Mₑ denotes the extracted model.

12. The method of claim 11, wherein a number of faces is the same in Mₒ and Mₑ.

13. The method of claim 11, wherein a relationships of the face-vertices is preserved such that if a face fₐ exists in Mₒ, there is a corresponding face f_{b} in Mₑ.

14. The method of claim 1, wherein the computed hash value is an MD5 hash value.

15. A method of determining 3D clones in a graphics-based application, comprising:
using shape information of a graphical object to generate a hash value of the graphical object;
indexing the graphical objects based on the hash values; and
determining static 3D clones from the indexed graphical objects.

16. The method of claim 15, further comprising:
removing duplicate vertices of the graphical object; and
sorting the vertices based on their coordinates into a list.

17. The method of claim 16, further comprising assigned each vertex with an ID based on its position in the sorted list.

18. The method of claim 17, further comprising sorting faces of the graphical object based on their vertex IDs.

19. The method of claim 18, Further comprising generating the hash value based on sorted faces.

20. The method of claim 15, further comprising detecting animated 3D clones from the static 3D model, a skeleton, and animation, wherein a hash value is used to represent each bone, and the hash value for the root bone will be used to index the skeleton.

21. The method of claim 20, further comprising indexing skeletons to group animated 3D models into groups, wherein models that have the same static 3D model and skeleton will be divided into the same group.

22. The method of claim 21, further comprising using pair-wise comparison to decide the animated 3D clones.
